(19) United States
(12) Patent Application Publication
(10) Pub. No.: US 2014/0122602 A1
(43) Pub. Date: May 1, 2014

(54) METHODS AND SYSTEMS FOR FACILITATING A MEETING BETWEEN TWO OR MORE MEMBERS OF A SOCIAL NETWORK

(71) Applicant: ArriveBefore Pty Ltd, Fitzroy North (AU)

(72) Inventor: Alan King, Hampton (AU)

(73) Assignee: ArriveBefore Pty Ltd, Fitzroy North (AU)

(21) Appl. No.: 14/067,030

(22) Filed: Oct. 30, 2013

(30) Foreign Application Priority Data
Oct. 30, 2012 (AU) 2012904784

(51) Int. Cl. H04L 29/08

(52) U.S. Cl. CPC H04L 67/22
USPC 709/204

(57) ABSTRACT

A computer-implemented method for facilitating a meeting between members of a social network, the method including the steps of receiving from a first member of the social network a selection of a future location of the first member from a first database; receiving from the first member a date and time when the first member will be at the future location; and broadcasting the future location together with the date and time when the first member will be at the future location to at least one member who is connected to the first member via the social network.

### CROSS-REFERENCE TO RELATED APPLICATIONS

The present application claims priority from Australian Patent Application No. 2012904784 filed Oct. 30, 2012, the disclosure of which is hereby incorporated herein by reference.

### FIELD OF THE INVENTION

The present invention relates generally to methods and systems for facilitating meetings between members of social networks. The invention particularly relates to computer-implemented methods and systems which facilitate face-to-face meetings between members of an online social network.

### BACKGROUND TO THE INVENTION

Social networks connect individuals with similar interests and aspirations to enable sharing of information, thoughts and ideas. Due to the prevalence of the Internet, communication between members of various social networks tends to be technology based. Online social networks such as Facebook, Twitter, Google+, FourSquare, LinkedIn and MySpace have changed the everyday interactions of many people, not only in the way in which they gather information, do business and buy and sell goods and services, but also in how they conduct their personal interactions. Online social networks provide means for members to reach more people, more easily than ever before. All over the world, people are using online social networks to reconnect with friends, their community, and to otherwise stay in touch.

An online social network generally includes a representation of each user, typically by way of a member profile, together with various links or connections to other members of the social network, sometimes referred to as “friends”. Online social networks provide a way for people to meet other people over a communications network. An online social network generally further provides web-based services which enable members to interact over the Internet, such as e-mail and instant messaging.

One particular advantage of online social networks is that physical proximity between members becomes irrelevant. Distance is no longer an object to maintaining regular contact with friends in faraway places. People who share interests and activities can be readily connected across political, economic, and geographic borders.

However, face-to-face meetings between members of social networks provide a real life connection and help to solidify regular online interactions. Accordingly, it would be desirable to facilitate face-to-face meetings between members of a social network.

A reference herein to a patent document or other matter which is given as prior art is not to be taken as an admission that that document or matter was, in Australia, known or that the information it contains was part of the common general knowledge as at the priority date of any of the claims.

### SUMMARY OF THE INVENTION

According to an aspect of the present invention, there is provided a computer-implemented method for facilitating a meeting between members of a social network, the method including the following steps: (a) receiving from a first member of the social network a selection of a future location of the first member from a first database; (b) receiving from the first member a date and time when the first member will be at the future location; and (c) broadcasting the future location together with the date and time when the first member will be at the future location to at least one member who is connected to the first member via the social network.

The method may further include the step of receiving from the first member a selection of a second member of the social network who will accompany the first member to the future location from a second database; wherein broadcasting the future location together with the date and time when the first member will be at the future location further includes broadcasting the future location to at least one member who is connected to the second member via the social network.

The second database will typically include a profile associated with each member of the social network. Moreover, it is to be under stood that social networks typically include links or connections which associate members of the social network with other members of the social network.

The step of receiving from the first member a selection of a second member who will accompany the first member to the future location may include presenting to the first member a list of members of the social network who are connected to the first member via the social network.

The step of receiving from the first member a selection of a future location of the first member may include presenting to the first member a list of possible locations.

In the event that the future location of the first member is not available for selection from the list of possible locations presented to the first member, the future location may be entered by the first member and added to the list of possible locations for future selection.

In one embodiment, the method further includes the step of broadcasting arrival of the first member at the future location to the at least one member who is connected to the first member.

Broadcasting arrival of the first member at the future location may include the following steps: (a) defining a perimeter around the future location of the first member of the social network; (b) tracking a present location of the first member of the social network; and (c) broadcasting arrival of the first member at the future location to the at least one other member of the social network who is connected to the first member and/or the member who will accompany the first member to the future location when the present location of the first member indicates that the first member is located within the perimeter defined around the future location.

The present location of the first member of the social network may be tracked using a mobile device associated with the first member. If the future location of the first member is represented by a single geographic point, the perimeter defined around the future location may be defined as a circle or spheroid having a predetermined radius.

A single geographic point may be defined by a single set of spatial coordinates.

If the future location of the first member is represented as a series of geographic points defining a first polygon, the perimeter defined around the future location may be defined as a second polygon, each point of the second polygon having a predetermined distance from the geographic points. Preferably, each point of the second polygon extends a predetermined distance from the geographic points outside of the first polygon formed by the geographic points.

According to a second aspect of the present invention, there is provided a system for facilitating a meeting between two or more members of a social network, the system including: (a) a first database storing data corresponding to a plurality of locations; (b) a second database storing data corresponding to a plurality of members of the social network; (c) a first selection component enabling a first member of the social network to select a future location of the first member from the first database and a date and time when the first member will be at the future location; and (d) a broadcasting component for broadcasting the future location together with a date and time when the first member will be at the future location to at least one member who is connected to the first member via the social network.

The system may further include a second selection component enabling a first member of the social network to select a second member of the social network who will accompany the first member to the future location from a second database; wherein the broadcasting component further broadcasts the future location together with a date and time to at least one member who is connected to the second member via the social network.

The selection component may present to the first member a list of members who are connected to the first member via the social network to enable the first member to select the second member of the social network who will accompany the first member to the future location from the second database.

The system may further include a position determining component for tracking a present location of the first member of the social network. The position determining component may be integrated with a mobile device associated with the first member.

The mobile device may be a mobile telephone or a handheld computing device including a position determining component. Preferably, the position determining device includes a global positioning system.

### BRIEF DESCRIPTION OF THE DRAWINGS

The invention will now be described in further detail by reference to the accompanying drawings. It is to be understood that the particularity of the drawings does not supersede the generality of the preceding description of the invention.

FIG. 1 is a flowchart demonstrating the steps involved is a method for facilitating a meeting between members of a social network according to an embodiment of the present invention.

FIG. 2 is a schematic diagram showing a computer-enabled system for facilitating a meeting between members of a social network.

FIG. 3 is a sample screen shot showing the display provided to a user in accordance with an embodiment of the invention.

FIG. 4 is a sample screen shot showing the selection component provided to a user.

FIG. 5 is a sample screen shot showing the display of FIGS. 4 and 5 with the completed selections.

FIG. 6 is a flowchart demonstrating the steps involved is a method for facilitating a meeting between members of a social network according to another embodiment of the present invention.

FIG. 7 is a schematic diagram showing various functional elements of the computer-enabled system of FIG. 2 in block form.

### DETAILED DESCRIPTION

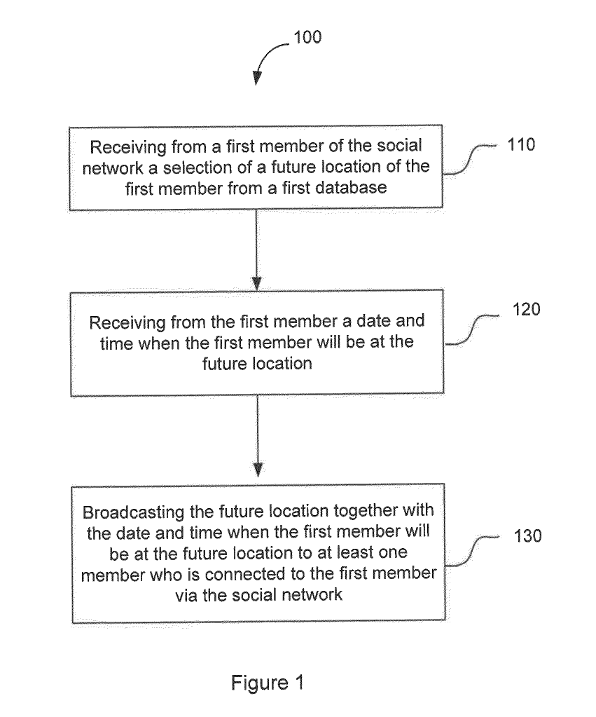

Referring firstly to FIG. 1, there is provided a flowchart illustrating the method for facilitating a meeting between members of a social network 100 in accordance with the present invention. At step 110, the system receives a selection of a future location of a first member of the social network from a first database. At step 120 the system receives a date and time when the first member will be at the future location. At step 130, the future location of the first member together with the date and time when the first member will be at the future location is broadcast to at least one member who is connected to the first member via the social network.

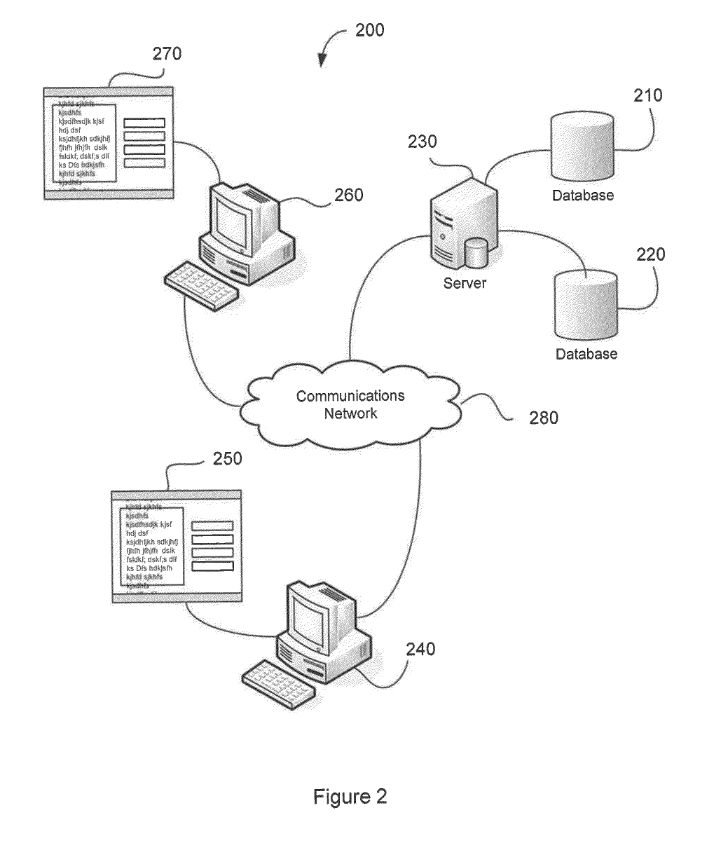

Referring now to FIG. 2, there is shown a computer-implemented system 200 for facilitating a meeting between members of a social network in accordance with an embodiment. Access is provided to a first database 210 storing data corresponding to a plurality of locations. This first database may or may not be maintained by the social network service. Access is further provided to a second database 220 storing data corresponding to a plurality of members of the social network. This second database is maintained by the social network service. Examples of social network services which may be involved in the implementation of the present invention include but are not limited to Facebook, Twitter, Google+, LinkedIn, MySpace and similar social network services maintaining a database of members with established connections established between members. Access to the data stored in the first and second databases 210, 220 is provided via a telecommunications network 280 such as a local area network (LAN), wide area network (WAN), the Internet or the like.

A first member of the social network, logs onto a website providing the service which facilitates meetings between members of a social network in accordance with the present invention. The service may be integrated with any online social network and is not limited to any particular social network, although facilitation of meetings is limited to members of a particular social network with existing connections via the social network. The website displays to the user a selection component 250 enabling the first member of the social network to select a future location of the first member. The selection component 250 is displayed on a user terminal 240 which may be a personal computing device. The personal computing device may comprise a desktop or laptop computer, personal digital assistant, smartphone, tablet or other device that is capable of communicating with a server 230 over the telecommunications network 280.

The server 230 receives the future location together with a date and time when the first member will be at the future location. The server 230 may further receive from the user terminal 240, selection of a second member of the social network who will accompany the first member to the future location. The future location together with a date and time when the first member will be at the future location is then broadcast to at least one member who is connected to the first member and at least one member who is connected to the second member via the social network, via a broadcasting component 270 made available on a recipient terminal 260 which may be a personal computing device. Alternately, it is to be understood that the future location together with a date and time when the first member will be at the future location may be broadcast to all members who are connected to the first member and all members who are connected to the second member via the social network.

Again, recipient terminal 260 may comprise a desktop or laptop computer, personal digital assistant, smartphone, tablet or other device that is capable of communicating with a server 230 over the telecommunications network 280.

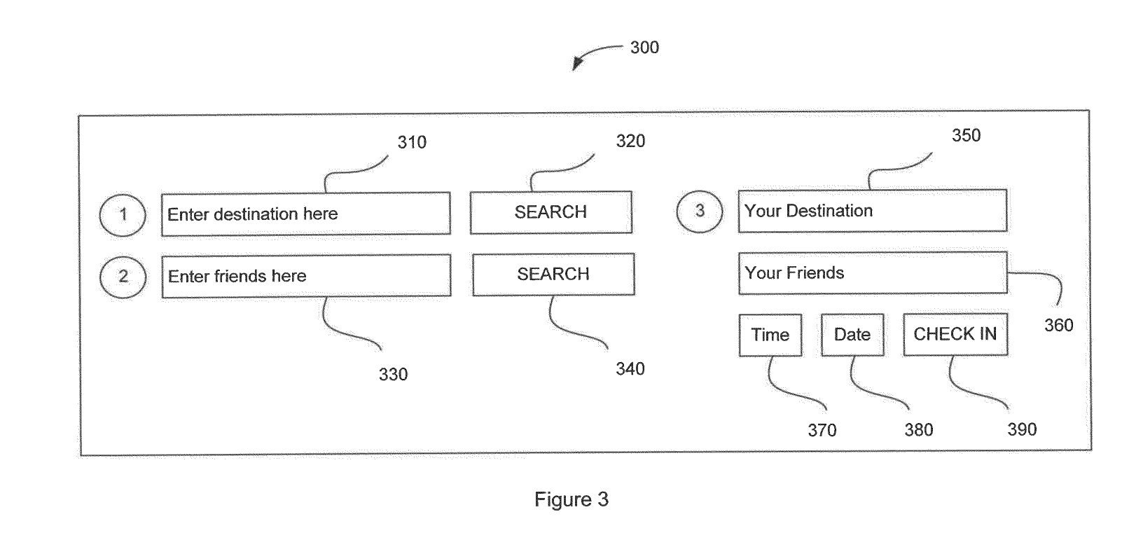

Referring now to FIG. 3 there is shown a sample screen shot showing the display provided to the first member on accessing the website providing the service which facilitates meetings between members of a social network. The first member is presented with the selection component 300 depicted in FIG. 3. In order to activate the data retrieval functionality which is described in the following paragraphs, the member must log in to the website using a username and password.

The first step in the process of arranging a face-to-face meeting with another member of the social network involves the first member entering their future location or destination that they intend to visit sometime in the future. The future location may be a specific destination such as a restaurant or hotel having a precise location which can be represented by a single geographic point, or could comprise an area or region, such as park, or a town or city or even a country, which would be represented on a map by a polygon defined by a series of geographic points. Each geographic point is defined by a single set of spatial coordinates.

The future location is entered in text box 310. By clicking on the “Search” button 360, the member may be prompted to log in to the relevant social network. In this scenario the first database storing data corresponding to a plurality of locations is hosted and maintained by the social network. However, it is envisaged that this location data need not necessarily be made available by the social network and could be sourced elsewhere or provided by the service facilitating meetings between members of a social network.

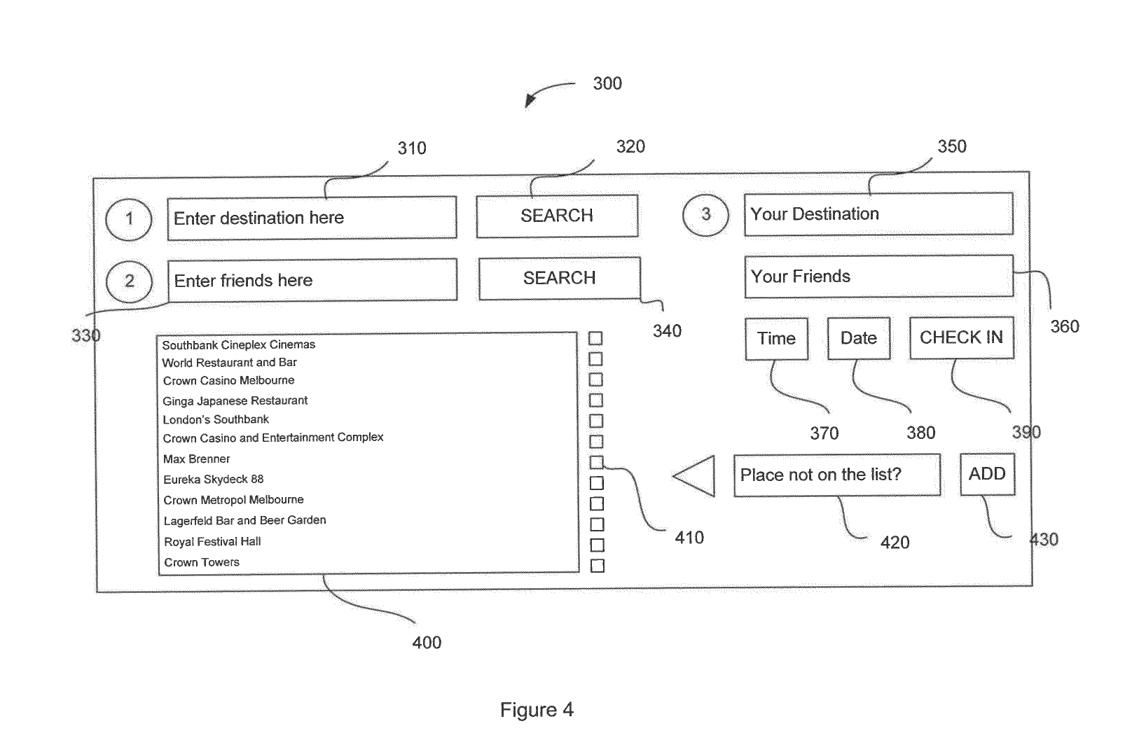

Referring now to FIG. 4, activating the search function using button 320 returns a list 400 of possible future locations from the first database. The member makes a selection of the future location from the list 400 by selecting appropriate tick box 410. In the event that the future location is not available for selection from list 400, the first member may elect to add the future location to the first database by activating the “Add” button 430. This action makes the location entered by the first member available for future selection by other members of the social network by adding to the store of data corresponding to a plurality of locations in the first database. Alternately, the location entered by the first member might be added to a store of locations in a separate database which is provided for the purpose of making the newly added location available for future selection by other members.

Once the future location is entered in text box 350, the first member may make a selection of at least one other member of the social network, who will accompany the first member to the future location. This other member maybe referred to as the second member herein. This generally occurs by entering at least a first letter of the name of a member of the social network who has an existing connection to the first member, e.g. another social network member who is tagged as a “friend”. Activating the “Search” button 340 displays a list of members of the social network with whom the first member has an existing connection and whose name starts with the first letter entered by the first member. Once the list is displayed, the first member can browse the list and make one or more selections of members who will accompany the first member to the future location. The names of the one or more selected members are entered into text box 360.

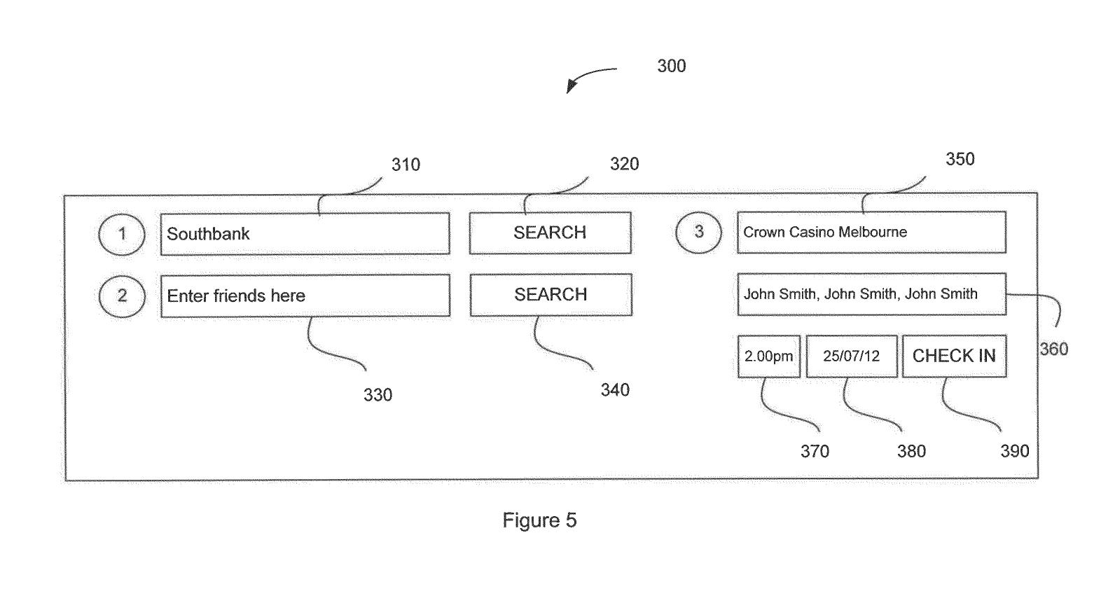

Once the future location is entered in text box 350 and the names of one or more members who will accompany the first member are entered into text box 360, the first member makes a selection of a time and date when the first member will be at the future location. Alternately, if the first member is travelling to the future location without an accompanying member, then the first member moves to selection of the date and time immediately subsequent to selecting the future location. Selection of the time and date may involve entering the time and date as text using a keyboard or keypad, or alternately, may involve selection of the time and date from a drop down list, or calendar in the case of the date. Once the time is entered in text box 370 and the date in entered in text box 380, the first member activates the “Check In” function by clicking on the “Check In” button 390. The completed text boxes 350, 360, 370 and 380 are shown in FIG. 5

Activating the “Check In” function causes the future location and the time and date that the first member will be at the location to be broadcast to at least one member of the social network who is connected to the first member via the social network. If the first member has selected a member who will accompany the first member to the future location, the future location and the time and date that the first member and the second or accompanying member will be at the location is further broadcast to at least one member who is connected to the second member who is accompanying the first member to the future location. This broadcast will be visible to the connected member or members of the social network, the next time that they log into the social network. The connected members of the social network may respond to the notification broadcast via the social network, or could make contact with the first member or second member who will accompany the first member to the future location via other means of communication such as by telephone.

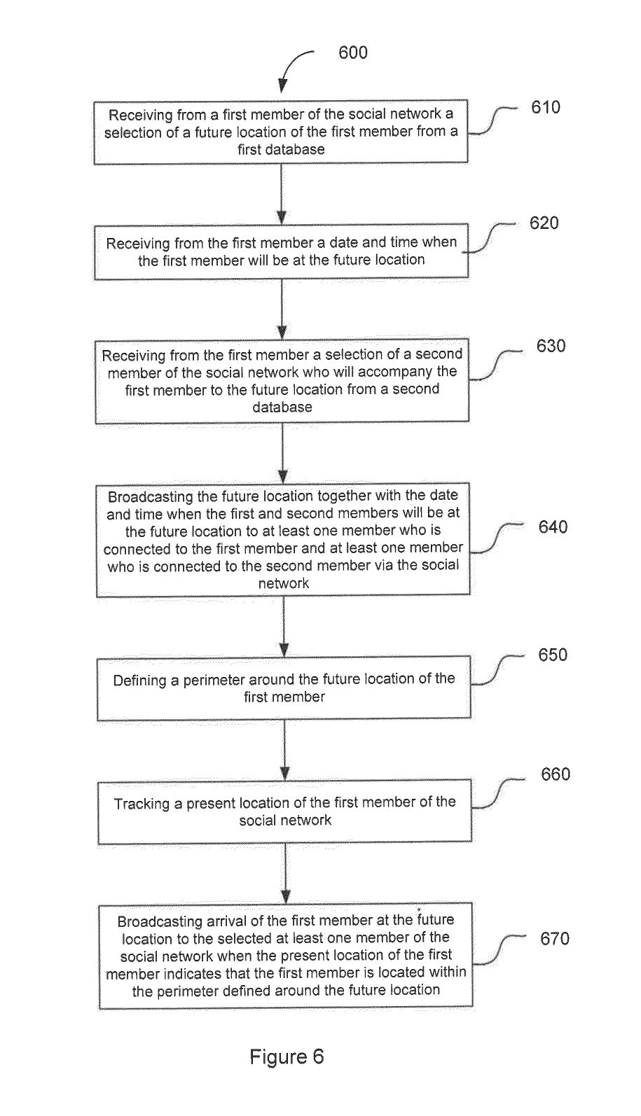

Referring now to FIG. 6, the “Check In” function may optionally be enhanced by allowing a positioning determining component such as global positioning system (GPS) to track the present location of the first member to enable the first member's arrival at the future location to be broadcast to the selected members of the social network. Firstly, this requires the first members to have on their person a mobile device including a position determining component. Examples of suitable devices are a mobile telephone or a handheld computing device including a position determining component.

The method 600 generally follows the steps also shown in FIG. 1. That is, at step 610, the system receives a selection of a future location of a first member of the social network from a first database. At step 620 the system receives a date and time when the first member will be at the future location. At step 630, the system receives a selection of a second member of the social network who will accompany the first member to the future location from a second database. At step 640, the future location of the first member together with the date and time when the first and second members will be at the future location is broadcast to at least one member who is connected to the first member and at least one member who is connected to the second member via the social network.

To facilitate broadcasting of the arrival of the first member at the future location, a perimeter or “geo-fence” is defined around the future location of the first member at step 650. At step 660, the present location of the first member is tracked as described. Then, at step 670, the arrival of the first member of the social network is broadcast to the selected members of the social network when the present location of the first member indicates that the first member is located within the perimeter defined around the future location.

As previously described, the future location may be a specific destination such as a restaurant or hotel having a precise location which can be represented by a single geographic point, or could comprise an area or region, such as park, or a town or city or even a country, which would be represented on a map by a polygon represented as a series of geographic points. In the case of a specific destination represented by a single geographic point which can be defined by a single set of spatial coordinates, the perimeter or “geo-fence” may be defined as a circle or spheroid having a predetermined radius. For example, the predetermined radius may be set as 100 metres, such that connected members of the social network will receive a broadcast when the first member arrives within 100 metres of the future location.

In the case of an area or region, such as park, or a town or city, which can be defined as a first polygon, each point of the first polygon defining the area or region is represented by a single geographic point which can be defined by a single set of spatial coordinates. In this case, the perimeter forms a second polygon wherein each point of the second polygon has a predetermined distance from the geographic points defining the first polygon. Generally, each point of the second polygon will extend a predetermined distance from the geographic points outside of the first polygon. Again the predetermined distance may be set at 100 metres or any other arbitrary distance such that the selected members of the social network will receive a broadcast when the first member arrives within the predetermined distance of the future location.

Referring back to FIG. 2, the system 200 may be implemented using hardware, software or a combination thereof and may be implemented in one or more computer systems or processing systems. In particular, the functionality of the user terminal 240 and recipient terminal 260 as well as the server 230, may be provided by one or more computer systems capable of carrying out the above described functionality.

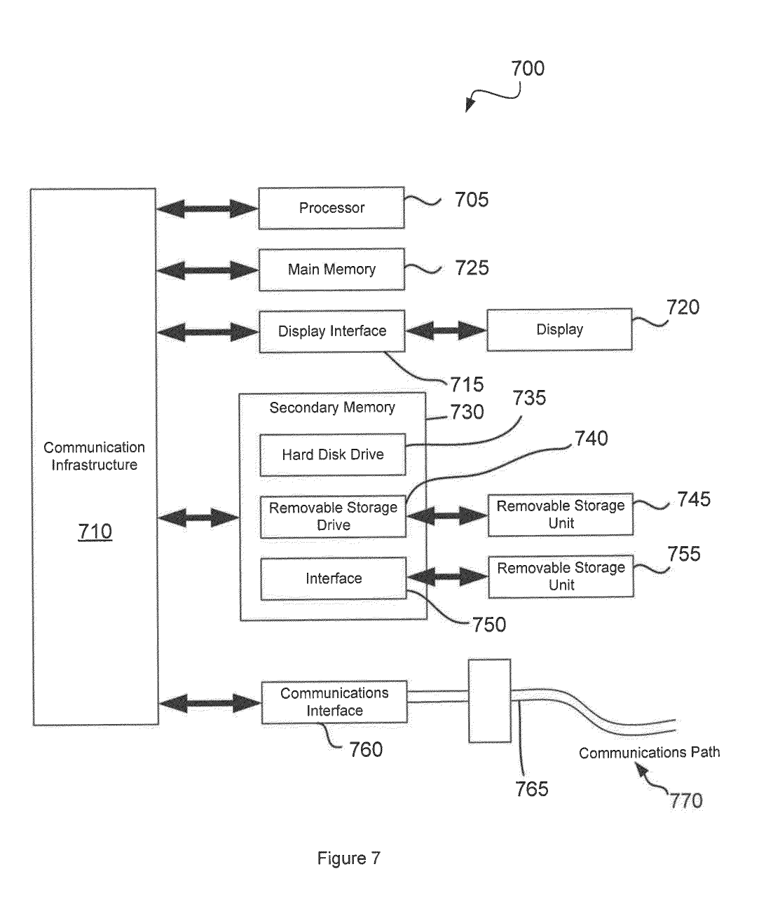

Such a computer system is illustrated in FIG. 7. In this Figure, an exemplary computer system 700 includes one or more processors, such as processor 705. The processor 705 is connected to a communication infrastructure 710. The computer system 700 may include a display interface 715 that forwards graphics, texts and other data from the communication infrastructure 710 for supply to the display unit 720. The computer system 700 may also include a main memory 725, preferably random access memory, and may also include a secondary memory 730.

The secondary memory 730 may include, for example, a hard disk drive 735, magnetic tape drive, optical disk drive, etc. The removable storage drive 740 reads from and/or writes to a removable storage unit 745 in a well-known manner. The removable storage unit 745 represents a floppy disk, magnetic tape, optical disk, USB etc.

As will be appreciated, the removable storage unit 745 includes a computer usable storage medium having stored therein computer software in a form of a series of instructions to cause the processor 705 to carry out desired functionality. In alternative embodiments, the secondary memory 730 may include other similar means for allowing computer programs or instructions to be loaded into the computer system 700. Such means may include, for example, a removable storage unit 740 and interface 750.

The computer system 700 may also include a communications interface 760. Communications interface 760 allows software and data to be transferred between the computer system 700 and external devices. Examples of communication interface 760 may include a modem, a network interface, a communications port, a PCMIA slot and card etc. Software and data transferred via a communications interface 760 are in the form of signals 765 which may be electromagnetic, electronic, optical or other signals capable of being received by the communications interface 760. The signals are provided to communications interface 760 via a communications path 770 such as a wire or cable, fibre optics, phone line, cellular phone link, radio frequency or other communications channels.

Although in the above described embodiments the invention is implemented primarily using computer software, in other embodiments the invention may be implemented primarily in hardware using, for example, hardware components such as an application specific integrated circuit (ASICs). Implementation of a hardware state machine so as to perform the functions described herein will be apparent to persons skilled in the relevant art. In other embodiments, the invention may be implemented using a combination of both hardware and software.

It is a feature and an advantage of the present invention, that a member of a social network is enabled to simply and efficiently advise multiple social network connections of a future location of the member by broadcasting a future time and date when the social network member will be at a particular location to other members of the social network. Moreover, the first member can also broadcast the future location to the connections of another member who is accompanying the first member to the future location. For example, if a social network member was going to be visiting New York, United States of America with a friend, it would be a simple matter to advise social network connections of the member and the member's friend, of the future location via a broadcast. Any of the social network members that will be, or could be, in the same location at the same time, can then make contact with the member of the social network ahead of time to arrange a meeting.

While implementation of the method for facilitating a meeting between two or more members of a social network has been described largely in the context of personal connection, or friends, it is easily foreseeable that the method and system of the present invention could be used in the same way for a member of a social network with a professional tendency such as LinkedIn, could use the method and system to advise professional contacts that the member will be at a particular location, for example to present a seminar or the like.

The method and system of the present invention may be enhanced by the opt in functionality provided by the follow up virtual “Check In” which subsequently advises the selected members of the social network when the first member physically arrives as the future location.

While the invention has been described in conjunction with a limited number of embodiments, it will be appreciated by those skilled in the art that many alternative, modifications and variations in light of the foregoing description are possible. Accordingly, the present invention is intended to embrace all such alternative, modifications and variations as may fall within the spirit and scope of the invention as disclosed.

The present application may be used as a basis or priority in respect of one or more future applications and the claims of any such future application may be directed to any one feature or combination of features that are described in the present application. Any such future application may include one or more of the following claims, which are given by way of example and are non-limiting in regard to what may be claimed in any future application.

What I claim is:

1. A computer-implemented method for facilitating a meeting between members of a social network, the method including the following steps:
(a) receiving from a first member of the social network a selection of a future location of the first member from a first database;
(b) receiving from the first member a date and time when the first member will be at the future location; and
(c) broadcasting the future location together with the date and time when the first member will be at the future location to at least one member who is connected to the first member via the social network.

2. A computer-implemented method for facilitating a meeting between members of a social network according to claim 1, further including the step of receiving from the first member a selection of a second member of the social network who will accompany the first member to the future location from a second database; wherein broadcasting the future location together with the date and time when the first member will be at the future location further includes broadcasting the future location to at least one member who is connected to the second member via the social network.

3. A computer-implemented method for facilitating a meeting between members of a social network according to claim 2, wherein the step of receiving from the first member a selection of a second member who will accompany the first member to the future location includes presenting to the first member a list of members of the social network who are connected to the first member via the social network.

4. A computer-implemented method for facilitating a meeting between members of a social network according to claim 2, wherein the step of receiving from the first member a selection of a future location of the first member includes presenting to the first member a list of possible locations.

5. A computer-implemented method for facilitating a meeting between members of a social network according to claim 4, wherein if the future location of the first member is not available for selection from the list of possible locations presented to the first member, the future location is entered by the first member and added to the list of possible locations for future selection.

6. A computer-implemented method for facilitating a meeting between members of a social network according to claim 1, further including the step of broadcasting arrival of the first member at the future location to the at least one member who is connected to the first member.

7. A computer-implemented method for facilitating a meeting between members of a social network according to claim 6, wherein broadcasting arrival of the first member at the future location includes the following steps:
(a) defining a perimeter around the future location of the first member of the social network;
(b) tracking a present location of the first member of the social network; and
(c) broadcasting arrival of the first member at the future location to the at least one other member of the social network who is connected to the first member and/or the member who will accompany the first member to the future location when the present location of the first member indicates that the first member is located within the perimeter defined around the future location.

8. A computer-implemented method for facilitating a meeting between members of a social network according to claim 7, wherein the present location of the first member of the social network is tracked using a mobile device associated with the first member.

9. A computer-implemented method for facilitating a meeting between members of a social network according to claim 7, wherein the future location of the first member is represented by a single geographic point and the perimeter defined around the future location is defined as a circle or spheroid having a predetermined radius.

10. A computer-implemented method for facilitating a meeting between members of a social network according to claim 9, wherein a single geographic point is defined by a single set of spatial coordinates.

11. A computer-implemented method for facilitating a meeting between members of a social network according to claim 7, wherein the future location of the first member is represented as a series of geographic points defining a first polygon and the perimeter defined around the future location is defined as a second polygon, each point of the second polygon having a predetermined distance from the geographic points.

12. A computer-implemented method for facilitating a meeting between members of a social network according to claim 11, wherein each point of the second polygon extends a predetermined distance from the geographic points outside of the first polygon formed by the geographic points.

13. A system for facilitating a meeting between two or more members of a social network, the system including:
(a) a first database storing data corresponding to a plurality of locations;
(b) a second database storing data corresponding to a plurality of members of the social network;
(c) a first selection component enabling a first member of the social network to select a future location of the first member from the first database and a date and time when the first member will be at the future location; and
(d) a broadcasting component for broadcasting the future location together with a date and time when the first member will be at the future location to at least one member who is connected to the first member via the social network.

14. A system for facilitating a meeting between two or more members of a social network according to claim 13, further including a second selection component enabling a first member of the social network to select a second member of the social network who will accompany the first member to the future location from a second database; wherein the broadcasting component further broadcasts the future location together with a date and time to at least one member who is connected to the second member via the social network.

15. A system for facilitating a meeting between two or more members of a social network according to claim 14, wherein the selection component presents to the first member a list of members who are connected to the first member via the social network to enable the first member to select the second member of the social network who will accompany the first member to the future location from the second database.

16. A system for facilitating a meeting between members of a social network according to claim 13, the system further including a position determining component for tracking a present location of the first member of the social network.

17. A system for facilitating a meeting between members of a social network according to claim 16, wherein a position determining component is integrated with a mobile device associated with the first member.

18. A system for facilitating a meeting between members of a social network according to claim 17, wherein the mobile device is a mobile telephone or a handheld computing device including a position determining component.

19. A system for facilitating a meeting between members of a social network according to claim 18, wherein the position determining component includes a global positioning system.
